(19) United States
(12) Patent Application Publication
(10) Pub. No.: US 2008/0158669 A1
(43) Pub. Date: Jul. 3, 2008

(54) PROJECTION SCREEN APPARATUS FOR USE WITH PORTABLE DIGITAL PROJECTORS

(75) Inventors: Michael W. O'Keefe, Cincinnati, OH (US); John E. Duncan, Arnelia, OH (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/618,356

(22) Filed: Dec. 29, 2006

(51) Int. Cl. G03B 21/56

(52) U.S. Cl. 359/443

(57) ABSTRACT

Projection screen apparatuses that comprise at least a first and a second projection screen member having different optical properties are described. These screen members can be adapted to connect to each other to form a self-supporting structure in which the first projection screen member is oriented in a viewing position and the second projection screen member is oriented in a support position.

### FIELD OF THE INVENTION

The invention relates generally to display apparatuses and more particularly to portable projection screens for use with portable digital projectors.

### BACKGROUND

Handheld digital projectors, capable of projecting pixilated images onto a separate viewing screen, but also capable of fitting within the space of a cell phone, PDA, digital camera, or similar handheld devices, have been proposed. Such projectors allow the user to project information stored in the handheld device onto a passive surface, such as a nearby wall, a sheet of paper, or other nearby object, so that it can be viewed by more than just one person.

### BRIEF SUMMARY

Unfortunately, wall surfaces or sheets of paper are typically not optimal for the purpose of viewing projected images. A wall, for example, may exhibit a decorative pattern or other non-uniformities that can obscure the projected image. A sheet of paper may also exhibit patterns, and it may lack the rigidity necessary to mount in a stable, flat configuration conducive to viewing.

It would be desirable to equip the users of compact projection devices with a projection screen that is optimized for that purpose, and that is also compact or portable. Different users, however, may have different needs or requirements, or a single user may have different needs or requirements at different times. For example, a user may want a screen optimized for front projection with a wide field of view, or a screen optimized for rear projection, or a front screen having a narrow viewing angle optimized for privacy. Thus, it would be desirable to equip the user with multiple such screens, and for such screens to be both compact for easy storage, and capable of configuring into a stable self-supporting structure conducive to viewing.

We describe herein, among other things, projection screen apparatuses that comprise at least a first and a second rigid projection screen member having different optical properties, where these screen members are adapted to connect to each other to form a self-supporting structure in which the first projection screen member is oriented in a viewing position and the second projection screen member is oriented in a support position. The apparatuses may also include a third screen member, a fourth screen member, and so on as desired. In some cases one or more of the screens may be oriented in a position that is simultaneously a viewing position and a support position.

We also describe projection screen apparatuses that comprise at least a first and a second projection screen member, these projection screen members having different optical properties. The projection screen apparatuses can also include a coupling mechanism for connecting the first projection screen member to the second projection screen member, the coupling mechanism preferably being capable of (a) forming the first and second projection screen members into a self-supporting structure in which the first projection screen member is oriented in a viewing position and the second projection screen member is oriented in a support position, and (b) reorienting the first and second projection screen members into a compact configuration.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1a is a perspective view of a projection screen apparatus comprising three screen members, shown in an unfolded state to form a self-supporting structure, but which can also fold onto each other for storage;

FIG. 1b is a plan view of the individual screen members of FIG. 1a, shown unconnected to each other;

FIG. 2a is a perspective view of a projection screen apparatus comprising three screen members in a notebook formation;

FIG. 2b is a perspective view of the projection apparatus of FIG. 2a, shown in a different configuration;

FIG. 3 is a perspective view of a projection screen apparatus comprising four screen members in a cubic arrangement; and

FIG. 4a is a schematic side view of a projection screen apparatus folded-up for convenient storage or transport, and

FIG. 4b is a perspective view of the apparatus after unfolding into an expanded self-supporting orientation.

### DETAILED DESCRIPTION OF ILLUSTRATIVE EMBODIMENTS

We now describe in more detail projection screen apparatuses that comprise at least two rigid screen members, the screen members having different optical properties in order to meet the varying needs of the user. The apparatuses can be used with handheld or otherwise portable digital projectors to create a portable display system.

Any given screen member can consist of a single, monolithic, and preferably rigid display screen, or it can include separate screen and frame portions. When a frame is used, the screen can be a flexible screen film or material that is held flat by the frame, for example by being stretched across the frame. The frame can be unitary, or can be made of separate pieces joined together, e.g., a top, bottom, left, and right frame piece. The separate frame pieces can be permanently joined together, or they can be detachably connected so that the frame can be disassembled. Alternatively, the frame may be collapsible. Whatever the design details, the frame (if present) preferably possesses sufficient rigidity to maintain its attached screen in a shape suitable for viewing, e.g., substantially flat.

The screen members can connect to each other by a wide variety of known or later developed coupling mechanisms. Preferably, the coupling mechanism is selected to permit relative rotation or pivotal motion of one screen member relative to another, so the screens can stay physically connected to each other while reorienting them between a compact configuration suitable for storage and an expanded configuration suitable for viewing. In one embodiment described more fully below, the screen members are connected in the form of a notebook, allowing the user to flip the individual screen member “pages” to the desired screen. The coupling mechanism can connect to a screen frame holding the actual display screen or it can connect to the screen itself. The coupling mechanism can also form a unitary body with a frame or screen. If desired, the coupling mechanism can contain a locking mechanism to lock a screen member in a desired position. One suitable coupling mechanism is a hinging device such as a spring hinge or friction hinge. Spring hinges move the screen members to an open or closed locked position if the user moves the screen members past a certain point. Friction hinges allow the screen members to maintain their relative position without slipping out of place. Other known hinging devices can also be used.

The screen members can also contain coupling mechanisms that utilize a separate connector piece or member. Examples include one or more tabs or pins formed on a screen member for insertion into corresponding slot(s) or hole(s) of a separate connector, or vice versa, adhesive strips, hook-and-loop fastening systems, and punched holes for use with ringed binders, such as three-ring binders. Other known coupling mechanisms can also be used.

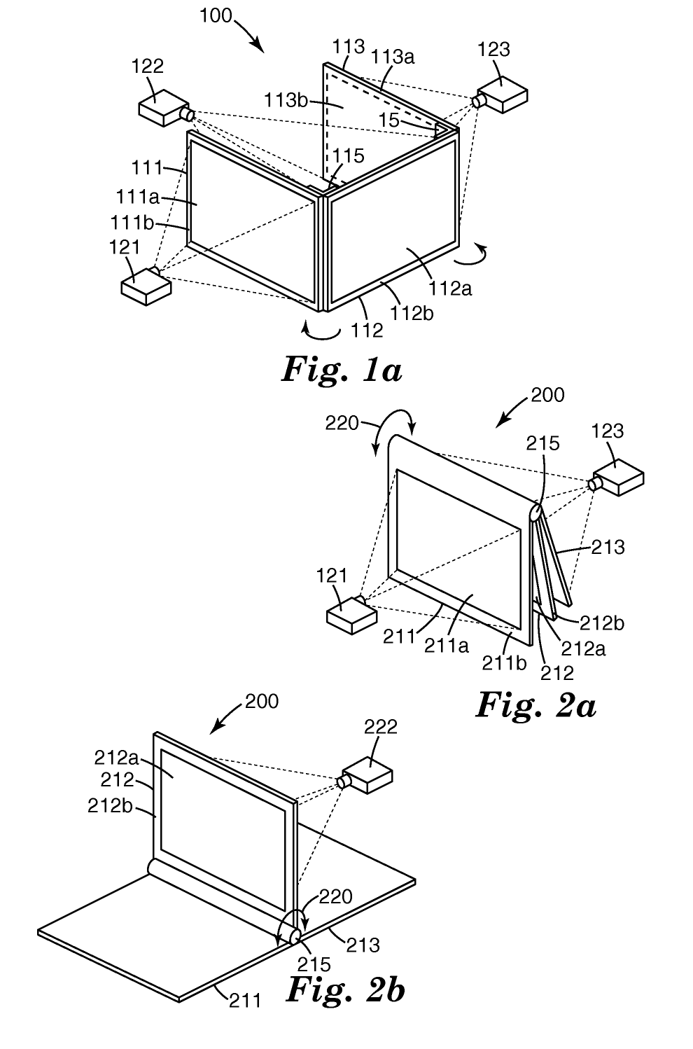

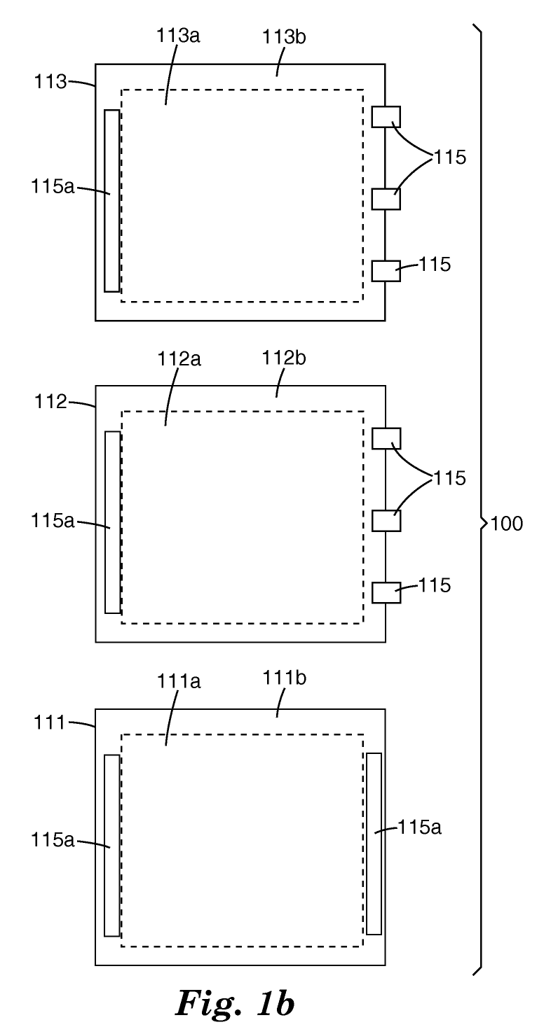

In an exemplary embodiment, the portable viewing apparatus is made up of three screen member types: a front screen type with a wide viewing angle for sharing; another front screen type with a narrow viewing angle for privacy; and a rear projection screen type. See also e.g. FIGS. 1-2 and accompanying description. This embodiment allows for three relatively popular but different viewing modes, including private movie viewing and public presentations, in a portable viewing apparatus.

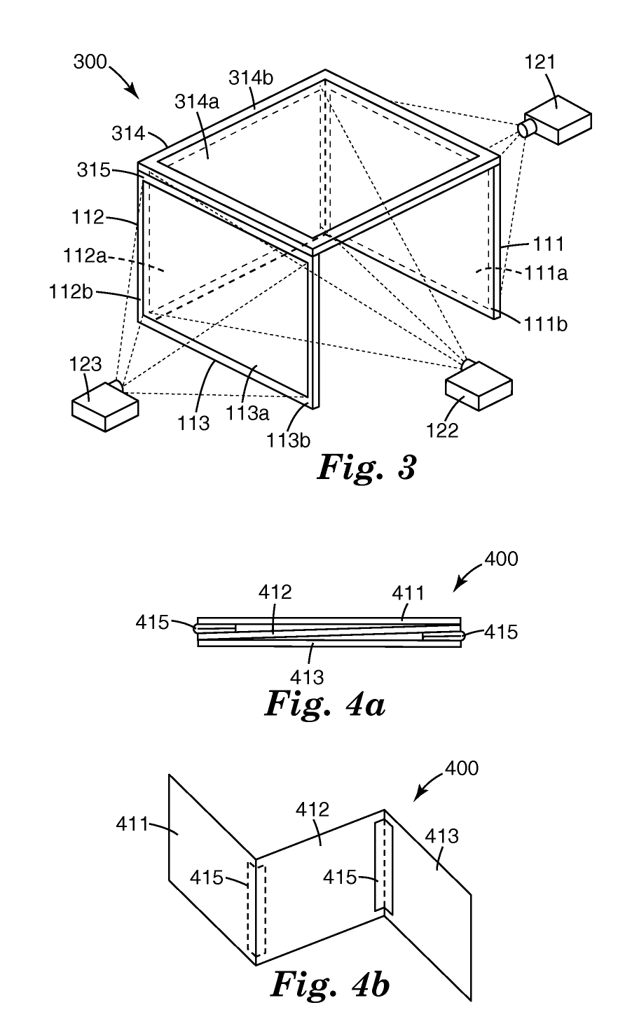

In another embodiment, the portable viewing apparatus can contain three or four screen members that can be arranged in a cubic design. One screen member can be situated on the top of the other screen members to provide shading or darkness to enhance rear projection operation (see FIG. 3).

In general, the screen portion of any given screen member can utilize any known screen material, such as the front-projection, rear-projection, or combination front/rear-projection screens known today or later developed. Reference is made, for example, to the wide variety of projection screens offered by Da Lite Screen Company, Warsaw, Ind. Reference is also made to the screens described in U.S. Pat. No. 4,025,160 (Martinez), “Dual Purpose Projection Screen”.

Turning now to FIG. 1a, we see there a perspective view of a projection screen apparatus 100 comprising a first screen member 111, a second screen member 112, and an optional third screen member 113. Screen member 111 includes a frame 111b and a screen 111a optimized for front projection and wide angle viewing, to be used with a compact front projector 121. Screen member 112 includes a frame 112b and a screen 112a optimized for rear projection, to be used with a compact rear projector 122. Optional screen member 113 includes a frame 113a and a screen 113b optimized for front projection and narrow angle viewing for privacy, to be used with a compact front projector 123. Screen members 111, 112, and 113 are connected with coupling mechanism(s) 115 and form a folding screen pack. The screen pack is shown in an unfolded state, but as long as coupling mechanisms 115 are flexible or hingeable the screen members can fold over upon themselves into a compact configuration for easy storage or transport. This compact configuration can be one in which the first, second, and third projection screen members are laid flat against each other.

The screen pack is preferably self-supporting, meaning that it can be used for viewing without any other support apparatus. In its unfolded or expanded state, the user can orient the projection screen apparatus so that a selected projection screen member faces him (i.e., is in a viewing position) and at least one other projection screen member helps to prop-up, stabilize, or otherwise support the selected screen member (i.e., is in a support position). The screen pack can also preferably be re-oriented so that the projection screen members exchange roles: the member formerly in the viewing position moves to a support position, and the member formerly in the support position moves to a viewing position. In some cases, one, some, or every projection screen member in the screen pack can be disposed simultaneously in both a viewing position and support position, as depicted for example in FIG. 1a.

At least some, and preferably all of the projection screen members in the screen pack preferably possess sufficient rigidity to provide support for at least one other projection screen member in the pack, and to make the projection screen apparatus self-supporting. In cases where a given projection screen member contains a projection screen but no frame, the projection screen itself can be made of a rigid material, or an initially flexible projection screen can be made rigid by lamination or other attachment to a rigid substrate. In cases where a projection screen member contains a separate projection screen and frame, the projection screen can be made of a flexible material and the frame can be made of a rigid material. In addition, both the frame and the projection screen can be made of rigid materials.

Preferably, the coupling mechanism can be or include a hinging device that hingably connects the first projection screen member to the second projection screen member. This hinging device can include, among other things, a conventional mechanical hinge, or a flexible strip of material such as adhesive tape or hook-and-loop fastening material. The hinging device can, if desired, also lock a given screen member into place so that it will not move when it is being used for viewing. The coupling mechanism can also be or include a wire structure that stores potential energy like a spring that “snaps” into place, similar to the folding mechanism of a pop-up tent. Such wire structures can also be used as the frame for one or more projection screen members. The coupling mechanism can alternatively be or include at least one hollow elbow shaped structure, whether rigid or flexible, and the screen members can include plugs that fit into this structure to produce the configuration of FIG. 1a. The coupling mechanism and/or frame(s) can also be or include rigid hollow tubes similar to those of a conventional dome tent in which multiple tubes are connected to each other with elastic running through the interior of the tubes and plug into each other to create a large stable structure. The coupling mechanism can also be or include tabs to be inserted into a separate connector, or adhesive strips that can form flexible hinges to attach the screen members to each other. The coupling mechanism can form a unitary body with one, some, or all of the projection screen members, or can be a separate structure.

The projection screen apparatus can in some cases be arranged so that more than one screen member can be used at a time. For example, the projection screen apparatus 100 can be placed on a tabletop or other surface and a first group of viewers can watch the rear projection screen member 112, a second group of viewers can watch the wide-angle front projection screen 111, and a third group of viewers or perhaps a single viewer can watch the narrow angle front projection screen 113. In the figure, separate compact front projectors 121, 123 illuminate screen members 111, 113 respectively, and a compact rear projector 122 illuminates screen member 112.

FIG. 1b is a plan view of the three screen members of FIG. 1a (111, 112, and 113) with coupling mechanisms 115, shown in an unconnected state and viewed from the back sides of the screen members. The coupling mechanisms can be adhesive or hook-and-loop strips that can form flexible hinges to attach the screens to each other, or they may be tabs to be inserted into a separate connector. An additional strip of material 115a, such as adhesive material (e.g. pressure sensitive adhesive or another type of adhesive) or hook-and-loop fastening material, may also be provided on the projection screen members as shown in FIG. 1b to facilitate the attachment of coupling mechanisms 115.

The screen members can in some cases be sold unconnected as a package set, and if desired they may be stored in, for example, a three ring binder. The back of the screen member can be laminated with a pressure sensitive adhesive, such that the screen member can be attached to a backing that includes an area for holes to be punched. The user can then bind them together. In addition, the screen members can have a pre-laminated pressure sensitive adhesive or other type of adhesive on one side, allowing the user temporarily to attach the screen to a self-supporting surface for support.

FIG. 2a is a perspective view of another projection screen apparatus 200 having multiple projection screen members. Display apparatus 200 includes a first screen member 211, a second screen member 212, and an optional third screen member 213, and may contain still more screen members as desired, with each screen member having optical projection characteristics different from the other screen members, e.g., front vs. rear projection, wide-angle vs. narrow-angle viewing, high-contrast vs. standard contrast, and so forth. Only screen members 211 and 212 are depicted as having separate projection screens 211a, 212a and frames 211b, 212b, respectively, but screen member 213 can have this construction as well. Screen members 211, 212, and 213 are pivotably connected on one side to form a notebook-style projection display apparatus. The screen members can be pivotably rotated with respect to each other via rotation 220 about a coupling mechanism 215, such that screen members 211 and 213 are held in a viewing position by using at least two of the members 211, 212, 213 as a triangle-shaped support. The screen members are connected via the coupling mechanism 215, which can include a known locking apparatus to hold the screen members in an upright, usable position. The coupling mechanism can also include a hinging device that can store potential energy like a spring in order to return the screen members to their usable position. The coupling mechanism can also include a low powered spring. The coupling mechanism can form a unitary body with one, some, or all of the projection screen members. FIG. 2a also shows compact front projectors 121, 123 illuminating projection screen members 211, 213 respectively.

In the configuration of FIG. 2a, the display apparatus 200 can be used simultaneously by two viewing groups. One viewing group can watch front projection screen member 211 and the other viewing group can watch front projection screen member 213.

The projection screen members of apparatus 200 can be pivotably reconfigured into the form shown in the perspective view of FIG. 2b. Instead of the previously described triangle configuration, the screen members 211, 213 lie flat in support positions and the other screen member is held in an upright viewing position. As in FIG. 2a, the screen members are held together with the coupling mechanism 215, which may include a locking mechanism to keep screen member 212 in its upright viewing position. Also shown is a compact front- or rear-projector 222. If desired, one of the screen members 211 or 213 can be eliminated to yield a display apparatus having only two projection screen members disposed in an L-shape configuration.

FIG. 3 is a perspective view of a projection screen apparatus 300 similar to apparatus 100 of FIG. 1a, but further containing a fourth screen member 314 arranged atop the others to form, together with the surface of the table on which they rest, a partially enclosed volume for increased darkness, less ambient light, and better rear screen contrast. The four screens are connected to each other with coupling mechanisms (not shown) similar to those described in above with respect to FIGS. 1a and 1b. This configuration is useful for viewing rear projection screen member 112. Similar to apparatus 100, other viewers can use the side front projection screen members 111 and 113 to view different images at the same time. The user can also have the option of using the other screens at different times. Screen member 314 is shown as comprising a separate projection screen 314a and frame 314b, but it can alternatively be of unitary design as can the other projection screen members.

As an alternative to apparatus 300, one of the side screen members 111 or 113 can be omitted and still maintain a partially enclosed volume. This arrangement may be acceptable particularly where the ambient light is incident primarily from one direction, e.g., from the general vicinity of projector 121 (in which case screen member 111 is maintained and screen member 113 is omitted) or from the general vicinity of projector 123 (in which case member 113 is maintained and member 111 is omitted).

FIG. 4a shows a schematic side view of a projection screen apparatus 400 in a folded-up or compact configuration for storage or travel. The apparatus 400 includes at least three projection screen members 411, 412, 413, each with different optical properties, and coupling mechanisms 415 similar to those described above that connect pairs of screen members in such a way that the members can be folded substantially flat as shown in FIG. 4a. When unfolded, the apparatus can be expanded to form the self-supporting structure shown in the perspective view of FIG. 4b.

While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the spirit and scope of the invention as defined by the appended claims.

1. A projection screen apparatus suitable for use with portable projectors, comprising:
a first rigid projection screen member and a second rigid projection screen member having different optical properties;
wherein the first projection screen member and the second projection screen member are adapted to connect to each other to form a self-supporting structure in which the first projection screen member is oriented in a viewing position and the second projection screen member is oriented in a support position.

2. The apparatus of claim 1, further comprising a coupling mechanism that connects the first and second projection screen members.

3. The apparatus of claim 2, wherein the coupling mechanism includes a hinging device.

4. The apparatus of claim 2, wherein the coupling mechanism includes a locking mechanism to hold the first projection screen member in a fixed position relative to the second projection screen member.

5. The apparatus of claim 2, wherein the coupling mechanism forms a unitary body with the first and second projection screen members.

6. The apparatus of claim 1, wherein the first projection screen member includes a first projection screen and a first frame.

7. The apparatus of claim 1, further comprising:
a third rigid projection screen member having optical properties different from those of the first and second projection screen members, the third rigid projection screen member being adapted to connect to at least one of the first and second projection screen members.

8. A projection screen apparatus suitable for use with portable projectors, comprising:
a first rigid projection screen member and a second rigid projection screen member having different optical properties; and
a coupling mechanism for connecting the first projection screen member to the second projection screen member;
wherein the coupling mechanism is (a) capable of forming the first and second projection screen members into a self-supporting structure in which the first projection screen member is oriented in a viewing position and the second projection screen member is oriented in a support position and (b) capable of reorienting the first and second projection screen members into a compact configuration.

9. The apparatus of claim 8, wherein the coupling mechanism hingably connects the first projection screen member to the second projection screen member.

10. The apparatus of claim 8, wherein the coupling mechanism includes a locking mechanism to hold the first projection screen member in a fixed position relative to the second projection screen member.

11. The apparatus of claim 8, wherein the coupling mechanism forms a unitary body with the first and second projection screen members.

12. The apparatus of claim 8, wherein the first projection screen member includes a first projection screen and a first frame.

13. The apparatus of claim 8, wherein the compact configuration is a configuration in which the first and second projection screen members are laid flat against each other.

14. The apparatus of claim 8, further comprising:
a third rigid projection screen member having optical properties different from those of the first and second projection screen members;
wherein the coupling mechanism further connects the third projection screen member to at least one of the first and second projection screen members.
